(19) United States
(12) Patent Application Publication
(10) Pub. No.: US 2003/0031119 A1
(43) Pub. Date: Feb. 13, 2003

(54) Method and apparatus for transmitting user data in an HSDPA mobile communication system

(75) Inventors: Seong-Hun Kim, Seoul (KR); Hyeon-Woo Lee, Suwon-shi (KR); Kook-Heui Lee, Songnam-shi (KR); Sung-Ho Choi, Songnam-shi (KR); Jin-Weon Chang, Yongin-shi (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 10/173,191

(22) Filed: Jun. 17, 2002

(30) Foreign Application Priority Data
Jun. 16, 2001 (KR) 34177/2001

(51) Int. Cl. H04L 5/20

(52) U.S. Cl. 370/200

(57) ABSTRACT

Transmitting user data in an HSDPA (High Speed Downlink Packet Access) mobile communication system by using an FCS (Fast Cell Selection) technique where an RNC (Radio Network Controller) transmits packet data only to a Node B that is best able to transmit data to a UE (User Equipment) on the downlink.

### PRIORITY

This application claims priority to an application entitled “Method and Apparatus for Transmitting User Data in an HSDPA Mobile Communication System” filed in the Korean Industrial Property Office on Jun. 16, 2001 and assigned Serial No. 2001-34177, the contents of which are hereby incorporated by reference.

### BACKGROUND OF THE INVENTION

1. Field of the Invention

The present invention relates generally to a packet data transmitting apparatus and method in an HSDPA (High Speed Downlink Packet Access) mobile communication system, and in particular, to an apparatus and method for transmitting packet data from an RNC (Radio Network Controller) only to the best cell for a UE (User Equipment) using FCS (Fast Cell Selection).

2. Description of the Related Art

HSDPA is a generic term that refers to data transmission schemes that bring high-speed data delivery to terminals by means of HS-DSCHs (High Speed-Downlink Shared Channels) and their related control channels in an asynchronous mobile communication system (hereinafter, referred to as UMTS: Universal Mobile Telecommunications System). To support HSDPA, AMC (Adaptive Modulation and Coding), HARQ (Hybrid Automatic Retransmission Request), and FCS have been proposed.

With reference to FIG. 1, a typical UMTS mobile communication system will be described along with the AMC, HARQ, and FCS.

Referring to FIG. 1, the UMTS mobile communication system includes a core network 100, a plurality of RNSs (Radio Network Sub-systems) 110 and 120, and a UE 130. Each RNS is comprised of an RNC 111 or 121, and a plurality of Node Bs 113 & 115 or 123 & 125. The RNCs 111 and 121 are categorized into a serving RNC (SRNC), a drift RNC (DRNC), or a controlling RNC (CRNC) according to their functions. An SRNC manages UE information and takes charge of data transmission between a UE and the core network. If data from the UE is delivered to the SRNC via an RNC other than the SRNC, the RNC is called a DRNC. A CRNC of a Node B is an RNC that controls the Node B. For example, if the RNC 121 manages the information of the UE 130, the RNC 121 is an SRNC. When data from the UE 130 is delivered to the RNC 121 via the RNC 111, the RNC 111 is the DRNC of the UE 130. The RNC 121 acts as the CRNC of the Node Bs 123 and 125.

AMC: This is a technique for adapting the modulation and coding format based on the received signal quality of the UE 130 and the channel condition between a particular Node B and the UE 130 to increase the use efficiency of the entire cell. Therefore, the AMC involves a plurality of modulation and coding schemes (MCSs). MCSs can be defined from level 1 to level n. In other words, the AMC is an adaptive selection of an MCS level according to the channel condition between the UE 130 and the serving Node B.

n-channel SAW HARQ (n-channel Stop And Wait HARQ) as a kind of HARQ: Two techniques are introduced to increase typical ARQ efficiency. That is, a retransmission request and a response for the retransmission request are exchanged between the UE 130 and the Node B, and defective data is temporarily stored and combined with corresponding retransmitted data.

FIG. 2 illustrates a HARQ-based retransmission between the UE 130 and the Node B 123, and an RLC (Radio Link Control) ARQ-based retransmission between the UE 130 and the SRNC 121, which is currently under discussion as functionality sharing between the SRNC 121 and the Node B 123 in HSDPA.

Referring to FIG. 2, the UE 130 and the Node B 123 each are additionally provided with layers called a MAC-h 201 and a MAC-h 205 to support AMC, HARQ and FCS. The MAC-h 205 takes charge of scheduling, MCS assignment and HARQ processing for a particular UE. Therefore, a general ARQ functionality exists between an RLC 207 of the SRNC 121 and an RLC 203 of the UE 130, and an HARQ functionality between the MAC-h 205 of the Node B 123 and the MAC-h 201 of the UE 130.

Specifically, since RLC retransmission occurs between the SRNC 121 and the UE 130, a long time is required for transmitting a retransmission request and a response for the retransmission request. On the other hand, a retransmission request and a response for the retransmission request based on HARQ between the UE 130 and the Node B 123 takes a relatively short time. Defective data are immediately discarded in the RLC retransmission, whereas defective data are temporarily stored and combined with corresponding retransmitted data to thereby reduce an error probability in the HARQ retransmission. The data are combined by chase combining (CC) or incremental redundancy (IR). The same data is transmitted at an initial transmission and a retransmission in the former method, and different data are transmitted at the initial transmission and the retransmission in the latter method.

FCS: When the UE 130 enters a soft handover region, it selects the cell that is best able to transmit the required data. To support the FCS, an HS-DSCH FP (HS-DSCH Frame Protocol) is defined for a lub interface between the Node B 123 and the SRNC 121 and for a lur interface between the SRNC 121 and the CRNC 111. The functionalities and structure of the HS-DSCH FP, however, are yet to be defined in detail.

The general operation of the HSDPA mobile communication system will be described with reference to FIGS. 1 and 2.

When the UE 130 supporting HSDPA enters a soft handover region defined as the overlapped region of the Node B 123 and the Node B 125, it establishes radio links with the Node Bs 123 and 125. The cells of the Node Bs that have radio links with the UE 130 are the active set of the UE 130. Data delivery from only the best cell in channel condition in the active set is FCS. The UE 130 periodically monitors the channel conditions with the cells 123 and 125 in the active set to check whether there is a cell better than the present best cell. If such a cell is detected, the UE 130 transmits a Best Cell Indicator (BCI) to the cells 123 and 125 in the active set to change the best cell. The BCI contains the identification (ID) of the new best cell. Upon receipt of the BCI, the cells 123 and 125 determine whether the BCI indicates them. Then, the new best cell transmits an HSDPA packet to the UE 130 on an HS-DSCH.

FCS is a technique assuming characteristics between a soft handover and a hard handover that occur in conventional mobile communication systems, to efficiently support the UE that changes its serving cell. The soft handover is a technique in which the UE maintains radio links with a plurality of Node Bs that send signals with strengths at or above an acceptable level without communication interruption between the UE and a UTRAN (UMTS Radio Access Network). The soft handover offers the benefit of continuous communication, but increases inter-cell interference. In contrast, the hard handover allows only one radio link for the UE. Assuming that the UE receives signals with strengths at or above an acceptable level from cell A and cell B, and cell A is a serving cell, if the signal from cell B satisfies a predetermined condition (e.g., it is better than the signal from cell B), the UE releases the radio link from cell A and establishes a new radio link with cell B. The hard handover reduces interference but causes communication interruption. While the FCS is similar to the hard handover in allowing only one radio link between a UE and a UTRAN and thus reducing interference, it reduces communication interruption as compared to the hard handover. To implement the FCS, the current proposed communication procedure is performed as follows.

When the UE is in a soft handover region, it establishes radio links with a plurality of cells and its SRNC transmits the same data to Node Bs in the active set of the UE. The Node Bs store the data in buffers for the case of being the best cell. When the best cell is changed, that is, FCS is implemented, the new best cell resumes a service with the UE using the stored data.

How the UE is wirelessly connected to the Node Bs in its active set (active set Node Bs) will first be described. When the UE is located in the soft handover region, an RRC (Radio Resource Control) entity of the SRNC recognizes it by a Measurement Report (MP) received from the UE. In general, the RRC entity transmits an RRC message Active Set Update to the UE. The Active Set Update message notifies the UE that it has entered the soft handover region, providing information about radio links to be established, so that the UE can receive downlink transmission on a plurality of radio links. After establishing the radio links, the UE transmits an Active Set Update Complete message to the RRC entity. FIG. 3 illustrates a signal flow for an RLC retransmission using FCS in a typical CDMA (Code Division Multiple Access) communication system.

Referring to FIGS. 1, 2 and 3, the RLC retransmission will be described below on the assumption that the Node B 125 is an active set Node B and the RNC 121 is the SRNC of the UE 130. It is to be noted in the following description that an active set Node B is a Node B other than the best cell Node B (BNB) in the active set and the best cell Node B is a Node B in the active set which is best able to receive a signal from the UE.

Once the UE 130 enters the soft handover region, the SRNC 121 recognizes it from a Measurement Report received from the UE 130 and determines to establish new radio links in step 301. This implies that the active set of the UE 130 includes at least two cells. The SRNC 121 transmits a Radio Link Setup Request message to Node Bs in the active set by an NBAP (Node B Application Protocol) in step 302. The Radio Link Setup Request message includes the IDs of the cells to which to establish radio links, timing information like frame offsets and chip offsets, and information needed to establish the radio links such as scrambling codes for the uplink and the downlink transmission, channelization codes, and transmission power control information. In step 303, the Node B 125 being an active set Node B establishes a radio link using the information included in the Radio Link Setup Request message and transmits a Radio Link Setup Response message to the SRNC 121. The Node B 125 receives data from the UE 130 on the uplink in step 304. The SRNC 121 then establishes transmission lines for sending user traffic on the lub interface by an ALCAP (Access Link Control Application Part) being a transmission signaling protocol, confirming that the radio links have been successfully established in step 305. An FP of the SRNC 121 synchronizes transport channels to the radio links in step 306 and transmits user data in a data frame to all the Node Bs that have established the radio links in step 307. The Node Bs 123 and 125 buffer the received user data in step 308. The Node B 123, which is selected as the best cell, starts data transmission to the UE 130 on its radio link and the Node B 125 is in the state where it can send the buffered user data. After preparing for data communication on the new radio links, the SRNC 121 notifies the UE 130 of the completed preparation for data communication by an Active Set Update message in step 309. The Active Set Update message contains a scrambling code and a channelization code for downlink transmission, transmission power control information, and the IDs of Node Bs that have established a radio link with the UE 130. In step 310, the UE 130 transmits an Active Set Update Complete message to the SRNC 121, notifying the receipt of the Active Set Update message. While one Node B is an active set Node B in FIGS. 2 and 3, a plurality of active set Node Bs may exist.

FIGS. 5 illustrates a signal flow for transmission of messages and user data between the UE, the Node Bs, and the SRNC in the case where the best cell is not changed.

Referring to FIG. 5, the physical layer (PHY) of the UE 130 transmits a BCI, a CQI (Channel Quality Indicator), and other information on a DPCCH (Dedicated Physical Control Channel) in step 501. Since the cells in the active set are informed of the scrambling code and channelization code of the DPCCH from the UE 130 in step 302 of FIG. 3, all the active set cells including the best cell 123 receive the BCI. The BCI contains the coded logical ID of the best cell that has the best radio link measured by the UE 130. The radio link status of a cell is estimated by measuring the reception strength of a CPICH (Common Pilot Channel) from the cell. The logical best cell ID is determined by agreement between the SRNC 121 and the UE 130 during set-up of an HS-DSCH or by the Active Set Update Complete message in step 309 of FIG. 3. Aside from the BCI, the DPCCH may have other information such as information about whether user data on the HS-DSCH has errors and the radio link quality of the best cell. Here, the active set Node B 125 checks whether the BCI indicates the Node B 125. If it does not, the Node B 125 does not receive the other information. If the BCI indicates the Node B 125, the Node B 125 transmits an MCS level and a reception indicator to the UE 130 based on the CQI and the ACK received from the UE. Since it is assumed that the best cell is not changed in FIG. 5, the BCI indicates the Node B 123. In step 502, the Node B 123 receives the BCI and determines an MCS level and user data to be transmitted based on the CQI and the ACK and transmits the CQI and a reception indicator by scheduling. The reception indicator indicates an action time of transmitting user data. The Node B 123 transmits the user data at the action time in step 503. In step 504, the UE 130 checks whether the received user data has errors and transmits a BCI, a CQI, and an ACK to the Node B 125. Steps 505 to 509 are a repetition of steps 501 to 504. In steps 510 to 540, user data exchange and inter-Node B buffer management occur in the SRNC 121, the Node B 125, and the Node B 123. The Node B 123 receives the user data from the SRNC 121 and transmits it to the UE 130, while the Node B 125 simply buffers the user data without transmitting it just for the case of being the best cell. The Node B 123 notifies the Node B 125 of the transmitted data so that the Node B 125 can discard the same data as transmitted from its buffer.

FIGS. 6 illustrates a signal flow for transmission of messages and user data between the UE, the Node Bs, and the SRNC in the case where the best cell is changed. For convenience's sake, it is assumed that an old best cell is the Node B 123, a new best cell is the Node B 125, and the UE 130 periodically transmits a BCI and determines to change the best cell from the Node B 123 to the Node B 125 at an arbitrary time point.

To switch the best cell from the Node B 123 to the Node B 125, the UE 130 transmits a BCI indicating the Node B 125 in step 601. Since the Node Bs 123 and 125 have already known the scrambling code and the channelization code for the uplink transmission, they can receive the BCI and determine whether the best cell is changed or not by checking the BCI. Thus, the Node B 123 neglects signals other than the BCI on the DPCCH, discontinuing transmission of an HS-DSCH. The Node B 125 determines an appropriate MCS by analyzing a CQI received from the UE 130 after the BCI, preparing for data transmission. The UE 130 transmits EQS (End Queue Status) information to the Node B 125 through its MAC-h and PHY to notify the Node B 125 of its reception status in step 602. The EQS information can be transmitted on a DPCCH or a DPDCH (Dedicated Physical Data Channel). In step 603, the Node B 125 determines what user data to send based on the EQS information and transmits the determined MCS information including information about the number of channelization codes to be used for data transmission and OVSF position information to the UE 130. The Node B 125 transmits the UE 130 the user data using the MCS in step 604. Steps 605, 606 and 607 are a repetition of steps 601, 603 and 604 except that the best cell has been changed to the Node B 125. Despite the change of the best cell, user data are exchanged and inter-Node B buffer management is performed in steps 610 and 620 in the same manner as steps 510 to 540 of FIG. 5.

As described above, once the UE 130 is located in the soft handover region and the radio connection is completed, the SRNC 121 transmits data both to the best cell Node B and the active set Node B. The best cell Node B discards data that has been transmitted successfully from its buffer and notifies the active set Node B of the transmitted data to discard the same data from the buffer.

If the best cell is changed, the UE reports its reception status to the new best cell Node B by predetermined signaling. It is proposed that the above procedure occur between the active set Node B, the best cell Node B, and the MAC-h of the UE. The inter-Node B buffer management requires a new signaling procedure and assignment of IDs to MAC-h SDUs (Service Data Unit). The SDU IDs are the sequence numbers (SNs) of the SDUs.

As described above, active set Node Bs discard user data destined for the UE without transmitting it, resulting in dissipation of buffer resources. For example, if four Node Bs including the best cell Node B are in the active set, they will store the same data. Yet, only the best cell Node B can send the data to the UE, while the other Node Bs discard them.

Moreover, the SRNC transmits the same data to the best cell Node B and the active set Node Bs but only the best cell Node B transmits it to the UE, thereby causing unnecessary dissipation of transmission resources between the SRNC and the Node Bs.

With regard to the inter-Node B buffer management, this is performed to make the buffers of the best cell Node B and the active cell nods B have the same data, increasing implementation complexity. While the best cell Node B discards successfully transmitted data, the active set Node Bs preserve the data because they do not transmit the data.

Then the best cell Node B notifies the active set Node Bs of the transmitted data so that they can discard the data from their buffers. When the best cell is changed, the new best cell Node B does not know the reception status of the UE. This implies that the UE must report its reception status by some signaling. Considering that this procedure happens in the active set Node Bs, the best cell Node B and the MAC-h of the UE, the signaling can be MAC-h signaling. The inter-Node B buffer management requires definition of a new signaling procedure between the entities responsible for the buffer management and assignment of IDs to MAC-h SDUs in the form of SNs. The SN assignment to MAC-h SDUs increases overhead.

### SUMMARY OF THE INVENTION

It is, therefore, an object of the present invention to provide a communication method and procedure for supporting FCS, solving the above conventional problems.

It is another object of the present invention to provide an apparatus and method for transmitting an FP data frame only to a best cell Node B.

It is also another object of the present invention to provide an apparatus and method for encouraging efficient use of lub transmission resources and efficient use of buffer resources in active set Node Bs.

It is a further object of the present invention to provide an apparatus and method for enabling a Node B to report the change of a best cell to an FP of its SRNC in order to minimize RLC retransmission requests.

It is also a further object of the present invention to provide an apparatus and method for efficiently managing an RLC buffer for a UE by enabling fast transmission of an RLC retransmission request when its best cell is changed.

It is still another object of the present invention to provide an FCS apparatus and method for transmitting user data using transmission resources efficiently at a fast cell selection in an HSDPA mobile communication system.

It is also still another object of the present invention to provide an apparatus and method for enabling an RNC to transmit user data only to a best cell Node B at a fast cell selection in order to efficiently use transmission resources in an HSDPA mobile communication system.

It is yet another object of the present invention to provide a method and apparatus for enabling each Node B to efficiently manage its memory for storing data received from an RNC in an HSDPA mobile communication system in which only a best cell Node B transmits high-speed packet data to a UE using FCS.

To achieve the above and other objects, an RNC, which controls a first Node B currently providing a service to a UE, the UE capable of receiving signals from the first Node B and at least one neighboring Node B, and the at least one neighboring Node B, establishes a transmission line with a new communicable Node B based on channel status information of the first Node B and the neighboring Node B received from the UE. The UE monitors the channel statuses with the first Node B and the neighboring Node B and transmits the ID of the best cell Node B in channel status to the first Node B and the neighboring Node B. The neighboring Node B transmits a BCSI (Best Cell Switching Indicator) to the RNC if the best cell Node B ID is identical to the ID of the neighboring Node B. Then, the RNC transmits user data on the transmission line to the best cell Node B being the neighboring Node B.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates the configuration of a typical CDMA mobile communication system;

FIG. 2 illustrates a protocol structure for an HSDPA mobile communication system;

FIG. 3 is a diagram illustrating a signal flow for transmission line establishment between a Node B and an RNC in a typical HSDPA mobile communication system;

FIG. 4 is a diagram illustrating a signal flow for transmission line establishment between a Node B and an RNC in an HSDPA mobile communication system according to an embodiment of the present invention;

FIG. 5 illustrates a user data transmission method after establishment of transmission lines in the procedure of FIG. 3 in the case where the best cell is not changed;

FIG. 6 illustrates a user data transmission method after establishment of transmission lines in the procedure of FIG. 3 in the case where the best cell is changed;

FIG. 7 illustrates a user data transmission method after establishment of transmission lines in the procedure of FIG. 4 in the case where the best cell is not changed;

FIG. 8 illustrates a user data transmission method after establishment of transmission lines in the procedure of FIG. 4 in the case where the best cell is changed;

FIG. 9A illustrates the structure of an FP data frame in the HSDPA mobile communication system according to the embodiment of the present invention;

FIG. 9B illustrates the structure of an FP control frame in the HSDPA mobile communication system according to the embodiment of the present invention;

FIG. 9C illustrates the structure of another FP control frame in the HSDPA mobile communication system according to the embodiment of the present invention;

FIG. 10 is a block diagram of an RNC controller for transmitting user data by the FP in the HSDPA mobile communication system according to the embodiment of the present invention;

FIG. 11 is a block diagram of an FP controller illustrated in FIG. 10;

FIG. 12 is a block diagram of a Node B for transmitting user data by the FP in the HSDPA mobile communication system according to the embodiment of the present invention;

FIG. 13 is a flowchart illustrating a user data transmission method in a UE in the HSDPA mobile communication system according to the embodiment of the present invention;

FIG. 14 is a flowchart illustrating a user data transmission method in the Node B in the HSDPA mobile communication system according to the embodiment of the present invention; and

FIG. 15 is a flowchart illustrating a user data transmission method in the RNC UE in the HSDPA mobile communication system according to the embodiment of the present invention.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

The present invention is intended to have an RNC transmit user data only to one of the Node Bs in the active set, i.e., the best cell Node B for transmitting to a UE on the downlink using FCS in an HSDPA mobile communication system. This leads to efficient memory management for active set Node Bs and decreases unnecessary signaling between the Node Bs and the RNC.

To achieve the goal, a newly defined transmission line setup between a Node B and an RNC, user data transmission, an FP structure, and the structures of the RNC and the Node B are necessary.

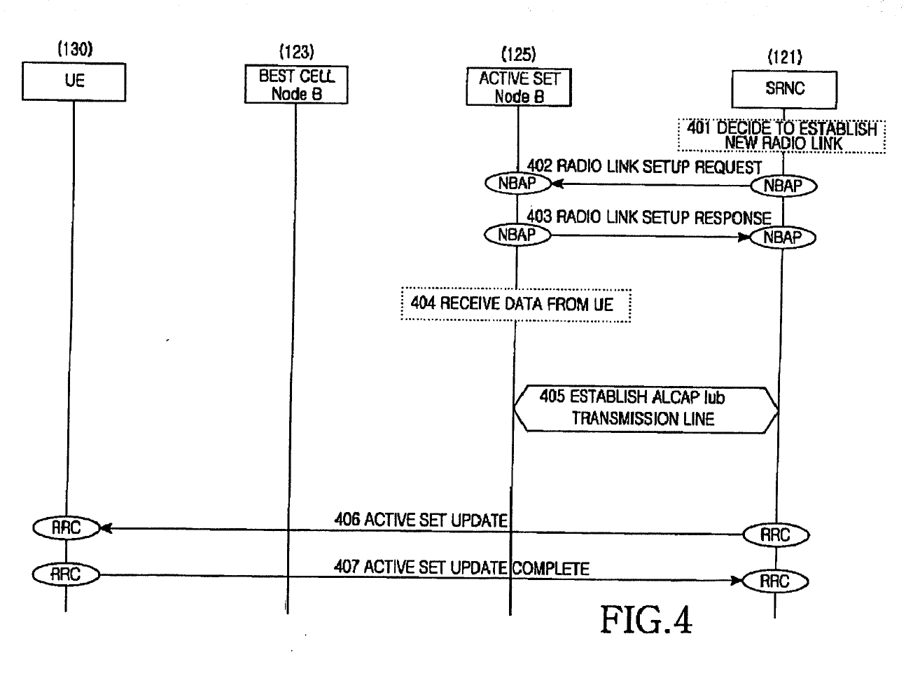

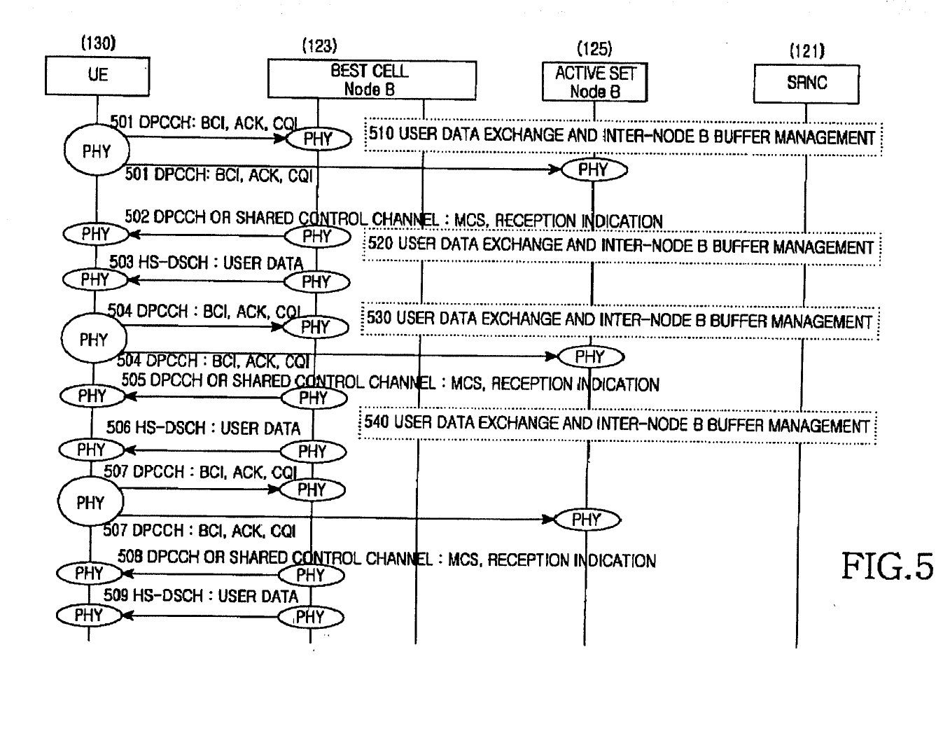

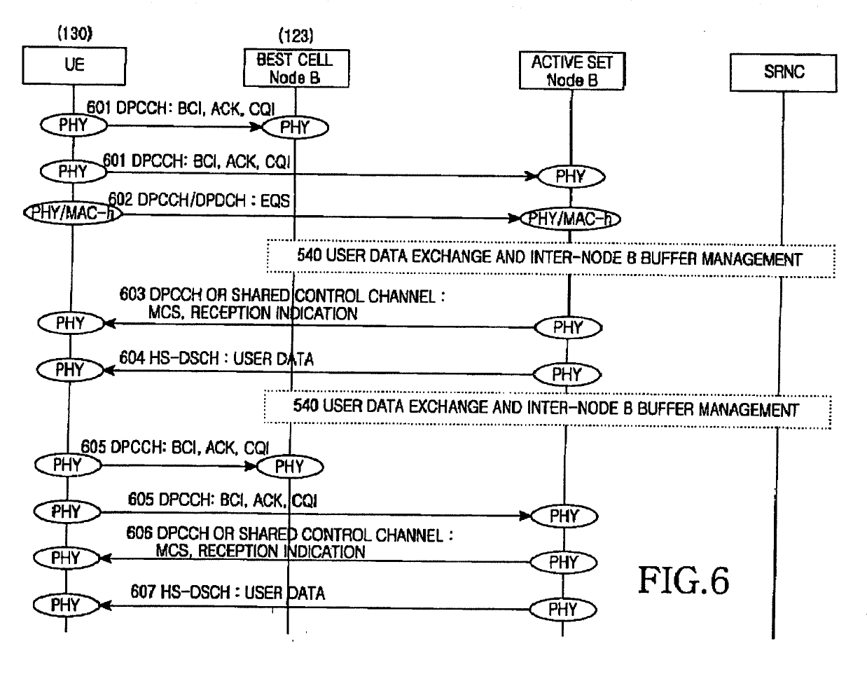

A description will first be made of a transmission line setup method between an RNC and a Node B according to an embodiment of the present invention with reference to FIG. 4. The Node B is one that should establish a new radio link with a UE when the UE enters a soft handover region.

FIG. 4 is a diagram illustrating a signal flow for setting up a transmission line for RLC retransmission using FCS in a CDMA mobile communication system using HSDPA according to the embodiment of the present invention. In FIG. 4, it is to be noted that Node Bs that should establish radio links with the UE are connected to the same RNC and the protocol entity of each node is marked with an oval. The best cell Node B 123 is a Node B that takes charge of a cell preserving a radio link before the UE 130 enters the soft handover region, and the active set Node B is a Node B that takes charge of a cell to establish a new radio link along with the entrance of the UE 130 in the soft handover region.

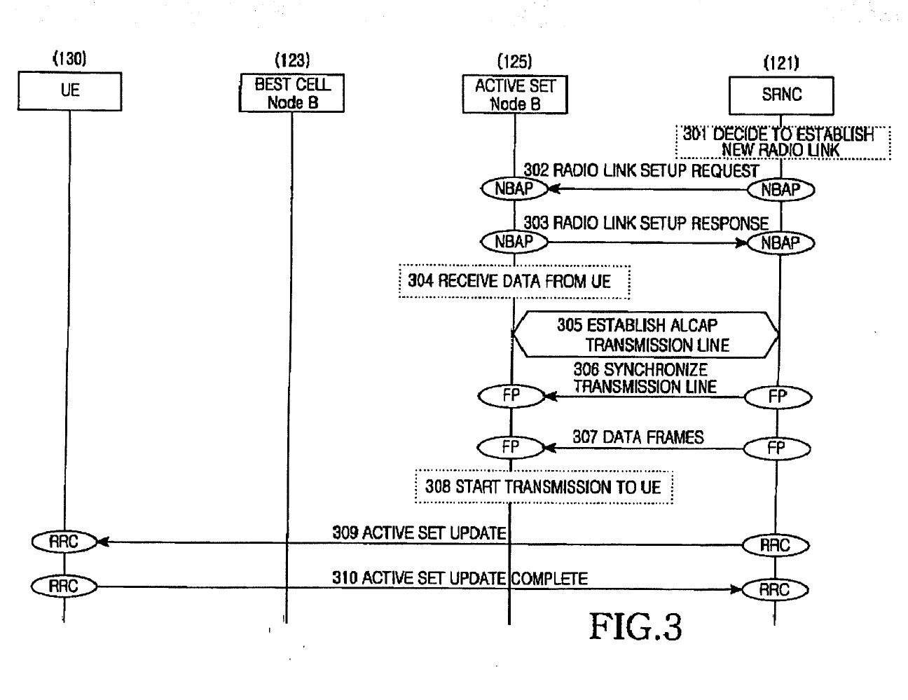

Referring to FIG. 4, a new radio link is established between the active set Node B 125 and the UE 130 in steps 401 to 405 in the same manner as steps 301 to 305 of FIG. 3. Upon completed setup of a lub transmission line with the active set Node B 125 in step 405, the SRNC 121 is ready for user data transmission to the active set Node B 125. No transmission line synchronization is needed for the HS-DSCH. The transmission line synchronization is a process of synchronizing the SRNC 121 and a Node B to a reference time. If the SRNC 121 implements scheduling, the transmission line synchronization is needed. However, the Node B is responsible for scheduling, which obviates the need for the transmission line synchronization.

In steps 406 and 407, the UE 130 and the SRNC 121 exchange an Active Set Update message and an Active Set Update Complete message. In these steps, they can determine the logical ID of the best cell by agreement.

In accordance with the present invention, while multiple cells may be members of the active set, only one of them transmits and receives at any time, potentially decreasing interference and increasing system capacity, as described above. The UE selects the best cell for transmitting on the downlink. Though not shown in FIG. 4, an FP 211 of the SRNC 121 continuously transmits data frames including user data to the best cell Node B 123. While the SRNC 121 transmits user data to all Node Bs with radio links established with the UE 130 in the conventional FCS, it transmits the user data only to the best cell Node B 123 on the radio link in the present invention. Though no data is transmitted to the active set Node Bs, the transmission lines are maintained between the active set Node Bs and the SRNC 121 so that data frame transmission can be carried out at any time when necessary. That is, the active set Node B 125 maintains the lub transmission line with the SRNC 121 and in addition is informed of a scrambling code that identifies the UE 130.

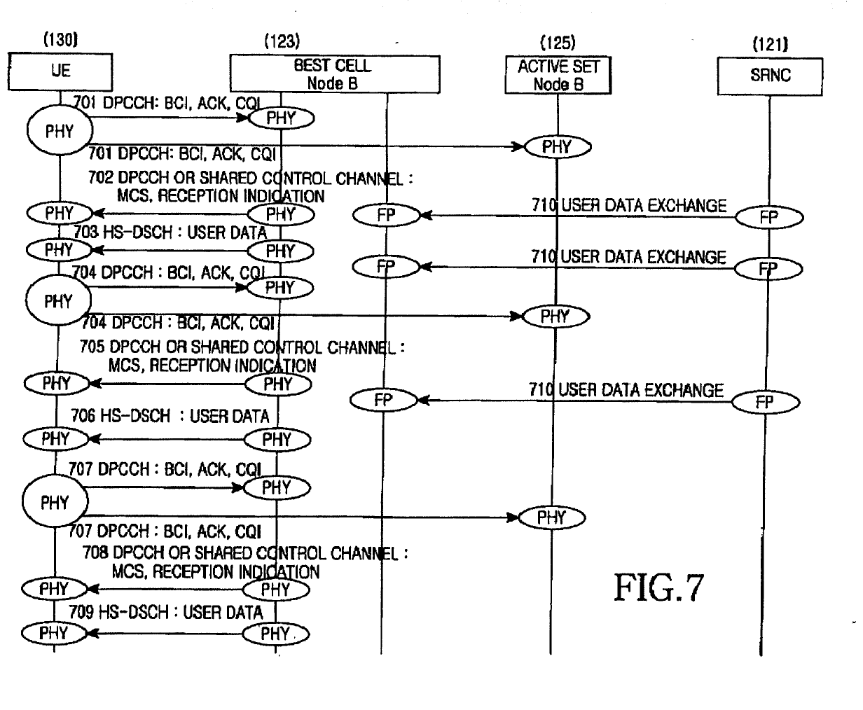

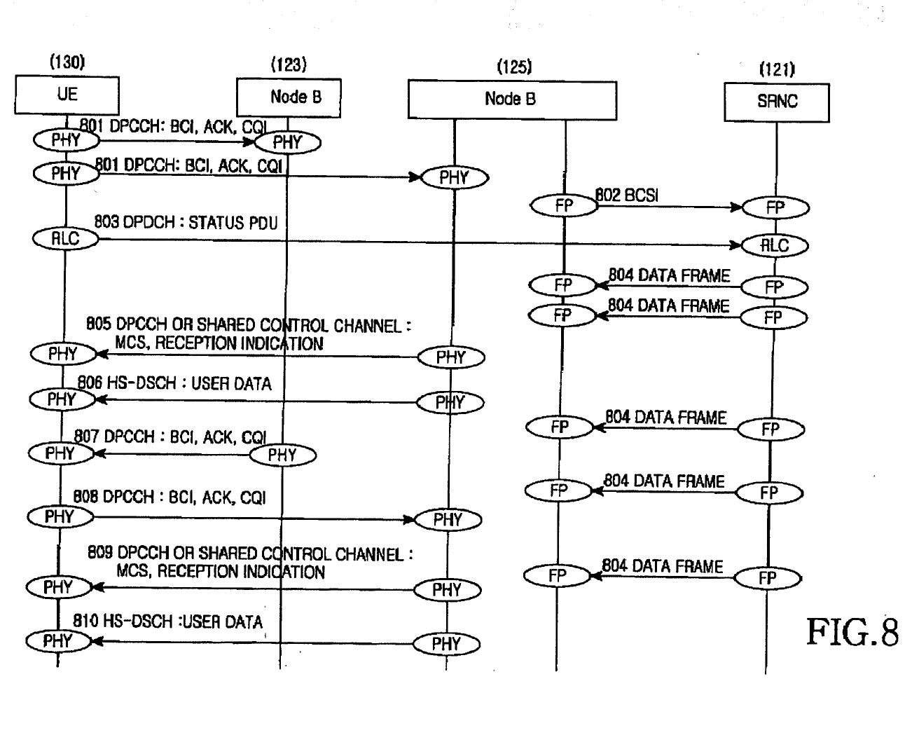

Data transmission according to the embodiment of the present invention will be described below with reference to FIGS. 7 and 8.

FIG. 7 illustrates a data transmission procedure after the transmission line is established between the Node B 125 and the SRNC 121 in the case where the best cell is not changed.

Referring to FIG. 7, the UE transmits a BCI, a CQI, and other information to the Node Bs 123 and 125 in step 701. The active set cells have already known the scrambling code and channelization code for the uplink transmission in step 402 of FIG. 4. Thus, the BCI is transmitted to all active set cell nodes and the best cell Node B 123. The BCI is transmitted on a DPCCH and contains the logical ID of the best cell which is determined based on the measured radio link statuses of the cells. The radio link status of a cell can be estimated by measuring the reception strength of a CPICH received from the cell. The best cell logical ID may be determined by agreement between the SRNC 121 and the UE 130 during an HS-DSCH set-up or in step 407 of FIG. 4. Aside from the BCI, the DPCCH may include information as to whether user data received on the HS-DSCH has errors or not (ACK/NACK) and the radio link quality of the best cell. The active set Node B 125 then checks whether the BCI indicates the Node B 125. If it does not, the Node B 125 does not receive the other information. On the other hand, if the BCI indicates the Node B 125, the Node B 125 transmits information about its MCS level and a reception indicator based on the CQI and the ACK to the UE 130. Since it is assumed that the best cell is not changed, the BCI indicates the Node B 123. Upon receipt of the BCI, the best cell Node B 123 determines an MCS to be used and user data for transmission based on the CQI and the ACK and transmits the CQI and a reception indicator to the UE 130 by scheduling in step 702. The reception indicator indicates an action time when the user data is to be transmitted. In step 703, the best cell Node B 123 transmits the user data to the UE 130. The UE 130 determines whether the user data has errors and transmits a BCI, CQI, and an ACK based on measurements of its PHY to the active set Node B 125 in step 704. Steps 705 to 709 are a repetition of steps 701 to 704. In accordance with the present invention, no user data exchange and inter-Node B buffer management are carried out between the SRNC 121, the best cell Node B 123, and the active set Node B 125. The SRNC 121 transmits user data only to the best cell Node B 123 by the FP in step 710.

FIG. 8 illustrates a data transmission procedure after the transmission line is established between the Node B 125 and the SRNC 121 in the case where the best cell is changed. Here, an old best cell node is the Node B 123 and a new best cell Node B is the Node B 125.

Referring to FIG. 8, the UE transmits a BCI to the Node Bs 123 and 125 periodically in steps 801, 807 and 808. When the UE determines to change the best cell from the Node B 123 to the new best cell Node B 125, it transmits a BCI indicating the Node B 125 on the DPCCH to the Node Bs 123 and 125 in step 801. Since the Node Bs 123 and 125 already known the scrambling code and channelization code for the uplink transmission in step 402 of FIG. 4, they can receive the BCI. Upon receipt of the BCI, the Node B 123 neglects signals received after the BCI, discontinuing transmission of the HS-DSCH to the UE 130. Meanwhile, the FP of the Node B 125 determines an MCS to be used based on a CQI received after the BCI, preparing for data transmission on the downlink. In step 802, the Node B 125 transmits a BSCI (Best Cell Switching Indicator) to the SRNC 121, indicating the change of the best cell. The FP of the SRNC 121 initiates transmission of data frames to the Node B 125, discontinuing data transmission on the lub transmission line between the Node B 123 and the SRNC 121 in step 804. The Node B 125 determines an MCS and a reception indicator based on the received data frame and transmits the MCS information and the reception indicator to the UE 130 by its PHY. Then the Node B 125 transmits user data to the UE 130 through the MAC and PHY in step 806.

Meanwhile, the PHY of the UE 130 notifies its RLC of the BCI transmission. If the RLC layer has operated in an AM (Acknowledged Mode), it transmits an RLC STATUS PDU (Protocol Data Unit) message on a DPDCH to the SRNC 121, providing information about its reception status up to the best cell switching time point in step 803. The RLC of the SRNC 121 retransmits RLC PDUs that the UE has not received yet through the Node B 123. Thus, the UE 130 can receive all data using FCS even when the best cell is changed.

While the BCSI is transmitted from the FP of the Node B 125 to the SRNC 121, the SRNC 121 continues transmitting data frames to the Node B123. The RLCs of the UE 130 and the SRNC 121 carry out retransmission of data frames transmitted from the SRNC 121 from step 802 to step 804. Therefore, the Node Bs 123 and 125 do not need to have the data that has not been transmitted to the UE yet.

As described with reference to FIGS. 4, 7 and 8, data transmission only to the best cell Node B requires a novel RLC operation and a novel FP.

In general, an RLC operates in an AM, UM (Unacknowledged Mode), or TM (Transparent Mode). Only the AM and UM are available in HSDPA. In the RLC UM, segmentation/assembly and encryption/decryption of data received from a higher layer are performed. In the RLC AM, segmentation/assembly, encryption/decryption, and retransmission of data received from a higher layer are performed. Here, retransmission in the RLC AM will be described.

In the RLC AM, SDUs received from the higher layer are segmented into RLC PDUs of a predetermined size, and the RLC PDUs are sequentially numbered and then transmitted to a receiver. The receiver memorizes the sequence numbers of defective RLC PDUs. If a predetermined condition is satisfied, the receiver transmits the SNs of the defective RLC to the transmitter by an RLC STATUS PDU. The transmitter then transmits the RLC PDUs corresponding to the SNs set in the RLC STATUS PDU. The predetermined condition can be a time period set by a timer, or omission of some RLC PDUs. In the present invention, the RLC of the UE can transmit the RLC STATUS PDU only if it receives a primitive CPHY-NOTIFY from the PHY of the UE. CPHY-NOTIFY functions to indicate the change of a best cell to the RLC. When the PHY of the UE 130 decides to change the best cell based on radio link quality measurements in step 801 of FIG. 8, its PHY transmits the primitive CPHY-NOTIFY to the RLC. Then, the RLC transmits the RLC STATUS PDU to the SRNC 121.

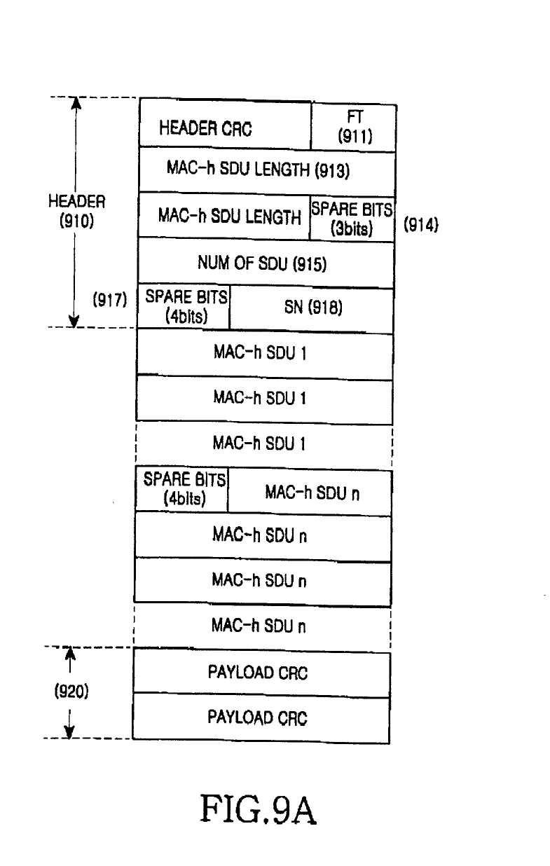

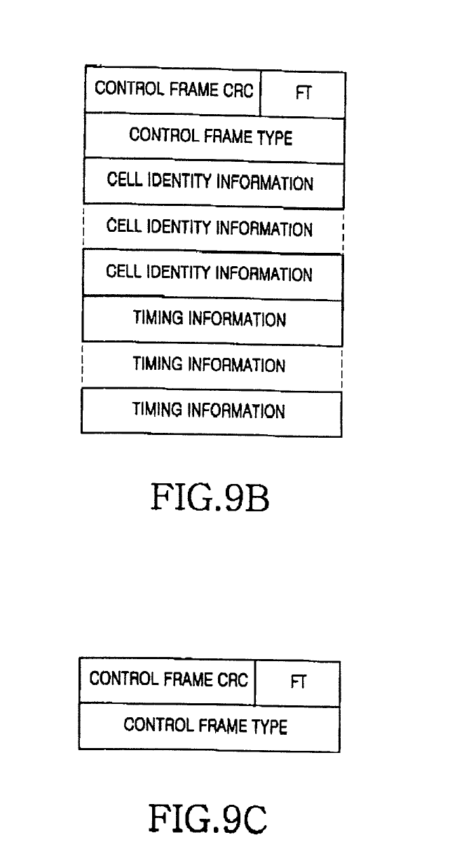

FIGS. 9A, 9B and 9C illustrate the architecture of the HS-DSCH FP according to the embodiment of the present invention.

Referring to FIGS. 9A, 9B and 9C, the FP handles a data frame and a control frame. The FP data frame is used on the lub interface, and the FP control frame transmits a BCSI according to the present invention. The data frame delivers data received from a higher layer of the FP and the control frame is used to perform an original FP control functionality. The FP is defined as a transport channel. A conventional transport channel takes charge of scheduling and thus inserts scheduling information in the header of a data frame. On the contrary, since a Node B performs HS-DSCH scheduling, it is not necessary to insert related scheduling information to the header of a data frame. Thus, timing and channelization code information are not loaded in the data frame, but MAC-h SDU information is loaded in the data frame.

Referring to FIG. 9A, the FP data frame is comprised of a header and a plurality of MAC-h SDUs destined for a UE. Each row in the data frame is one byte and reference numeral 910 denotes a 5-byte header. The header 910 includes Frame Type (FT) 911 indicating whether the frame is a control frame or a data frame, MAC-h SDU Length 913 indicating the length of each SDU in the payload, Spare Bits 914 and 917, NumOfSDU 915 indicating the number of SDUs in the data frame, and Serial Number 918 being the ID of the data frame. The Serial Number is an integer. The FT 911 is one bit and the MAC-h SDU Length 913 is one byte. One data frame accommodates SDUs of the same size. The Spare Bits 914 and 917 are reserved for future use in relation to the MAC-h SDU Length 913 and the SN 918, respectively. The NumbOfSDU 915 is one byte and the last two bytes in the data frame are filled with payload CRC (Cyclic Redundancy Check) 920.

FIG. 9B illustrates an FP control frame, i.e., a BCSI control frame with a cell ID and timing information and FIG. 9C illustrates an FP control frame, i.e., a BCSI control frame without the cell ID and timing information. The Node B transmits a BCSI to the FP of the SRNC, indicating that the best cell has been changed so that the SRNC can transmit data to the new best cell Node B. Since the SRNC knows the cell ID, the cell ID may not be needed. However, to help the FP of the SRNC to take an appropriate action, the cell ID can be inserted. For example, a corresponding transport line ID such as an AAL2/ATM path identifier can be inserted in that position. Considering data transmission starts to the new best cell Node B when the SRNC receives the BCI, the timing information is not necessary. However, the timing information can also be transmitted for a future optional use. The most important information that the BCSI delivers is the change of the best cell. The information can be provided simply by indicating the type of a control frame, i.e., a BCSI control frame without any other additional information. Accordingly, the control frame can be formatted as illustrated in FIG. 9C.

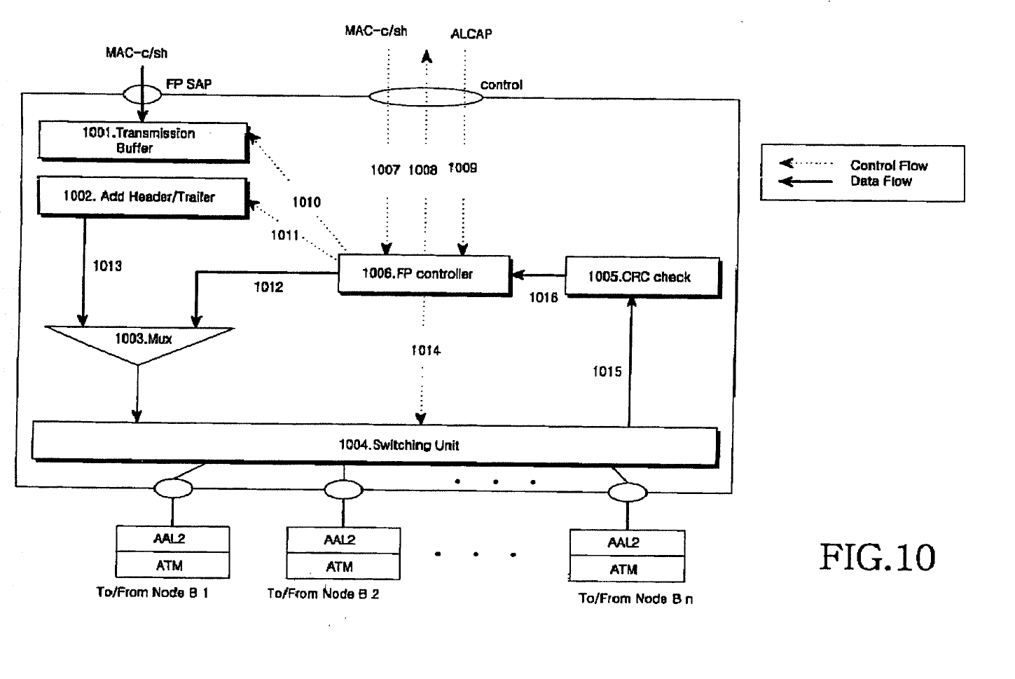

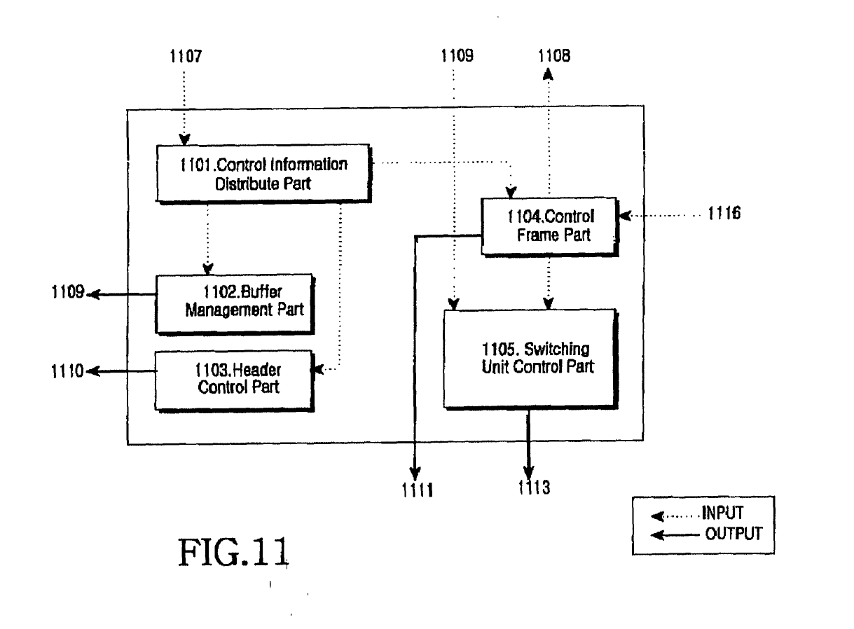

FIG. 10 illustrates the structure of an RNC for transmitting an HS-DSCH FP according to the embodiment of the present invention. Referring to FIG. 10, a transmission buffer 1001 temporarily stores user data received from a MAC-c/sh until it is accumulated to one data frame. The size of a data frame is not limited and determined by the number of MAC-h SDUs received at one time and the size of each SDU. When the transmission buffer 1001 has data enough to construct a data frame, it outputs the data to a header and trailer inserter 1002. The header and trailer inserter 1002 adds a header and a trailer to the received data. The trailer is a 2-byte payload CRC placed at the end of the format illustrated in FIG. 9A. The trailer is determined by CRC operation of MAC-h SDU 1 to MAC-h SDU n of FIG. 9A. Information to be filled in the header is provided by an FP controller 1006. A multiplexer (MUX) 1003 scrambles a control frame received from the FP controller 1006 and the data frame received from the header and trailer inserter 1002 in an order determined by the FP controller 1006. When both the header and trailer inserter 1002 and the FP controller 1006 have transmission data, it is determined which data has priority. The data frame output from the MUX 1003 is transmitted to a receiving Node B through a switching unit 1004.

A control frame received from the Node B is input to a CRC checker 1005 through the switching unit 1004. The CRC checker 1005 checks a header CRC from the received data and if no errors are detected in the data, it outputs the data to the FP controller 1006. Since no data delivery from the Node B to the RNC is defined in the HS-DSCH FP, reception of a data frame from the Node B is not considered.

FIG. 11 is a block diagram of the FP controller 1006 illustrated in FIG. 10.

Referring to FIG. 11, a control information distributor 1101 distributes control information 1007 received from the MAC-c/sh to a buffer manager 1102, a header controller 1103, and a control frame controller 1104. The control information 1107 includes information about the number of MAC-h SDUs, the size of each MAC-h SDU, and the amount of non-transmitted data remaining in the RLC buffer. The information about the number of MAC-h SDUs and the size of each MAC-h SDU is provided to the buffer manager 1102 and the header controller 1103, and the amount of the data remaining in the RLC buffer, to the control frame controller 1104. The buffer manager 1102 indicates a time when data stored in the transmission buffer 1001 is output to the header and trailer inserter 1002 based on the received control information. The header controller 1103 constructs header information for a data frame using the received control information. The control frame controller 1104 transmits a Capacity Request control frame to a Node B using the received control information when necessary. Upon receipt of a Capacity Allocation control frame 1008, the control frame controller 1104 delivers it to the MAC-c/sh. The switching controller 1105 controls connection between the RNC to Node Bs. As described before, the SRNC establishes transmission lines with the Node Bs by ALCAP in step 405 of FIG. 4. The transmission lines are AAL2/ATM. Then the switching controller 1105 receives the IDs of the Node Bs that have established the transmission lines by the Capacity Allocation control frame 1008. The switching controller 1105 adds the IDs of the Node Bs except the best cell Node B to an ASB (Active Set Node B). The switching controller 1105 controls the switching unit 1004 to maintain only the connection with the best cell Node B. Upon receipt of a BSCI control frame, the control frame controller 1104 transmits the ID of the new best cell to the switching controller 1105. The switching controller 1105 then updates the best cell Node B and reestablishes the connection. Referring to FIG. 4, the Node B 125 transmits the BCSI control frame and the control frame controller 1104 transfers it to the switching controller 1105. The switching controller 1105 controls the switching unit 1004 to release the connection from the Node B 123 and establishes a connection with the Node B 125. Since AAL2/ATM connections have already been made with the Node Bs 123 and 125, the above connection release and establishment means internal connection in the switching unit 1004.

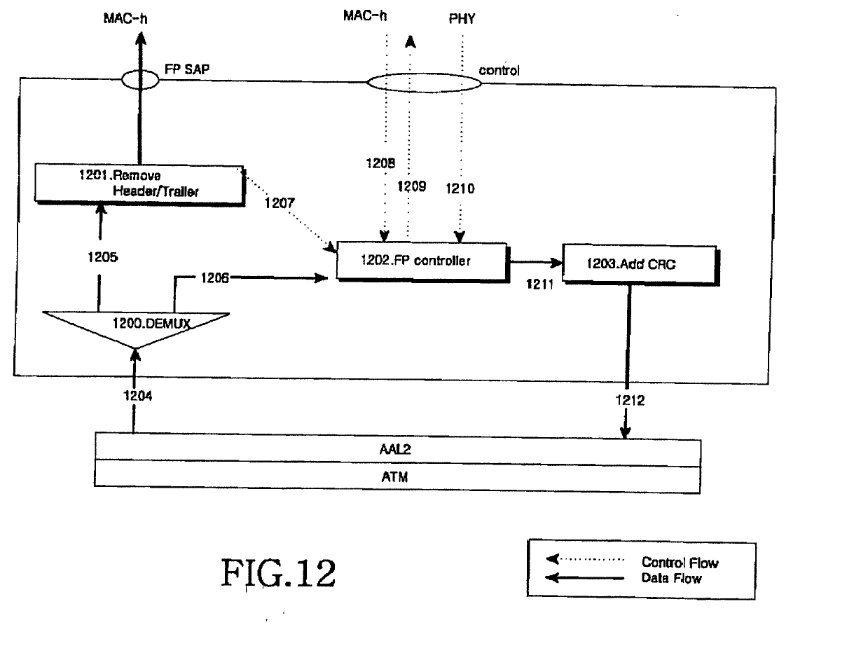

FIG. 12 is a block diagram for a node B for transmitting user data by the FP in the HSDPA mobile communication system according to the embodiment of the present invention. Upon receipt of a frame from a lower layer through an AAL2/ATM transmission line 1204, a demultiplexer (DEMUX) 1200 routs the frame to a header remover 1201 or an FP controller 1202 according to an FP field of its header (1205, 1206). The header remover 1201 removes the header from the data frame and outputs header information to the FP controller 1202 (1207). The FP controller 1202 transmits the header information to the MAC-h (1208). The header remover 1201 additionally checks errors in the data frame by operating a header CRC and a payload CRC. If errors are found, the data frame is discarded and if no errors are found, the payload is routed to the MAC-h. Reference numerals 1208 denotes information directed from the MC-h to the FP controller 1202 as needed to construct a control frame but not defined in the present invention. Reference numeral 1209 denotes the header information directed from the FP controller 1202 to the MAC-h. Reference numeral 1210 denotes information directed from the PHY of the node B to the FP controller 1202, indicating that the best cell has been changed. Upon receipt of the control information 1210, the FP controller 1202 transmits the RNC a BCSI control frame with a CRC added in a CRC adder 1203 via the AAL2/ATM line. As compared to the conventional technology, the RNC FP illustrated in FIGS. 10 and 11 can transmit user data only to the best cell node B and the node B FP illustrated in FIG. 12, upon recognizing the change of the best cell, can notify the RNC FP of the best cell change.

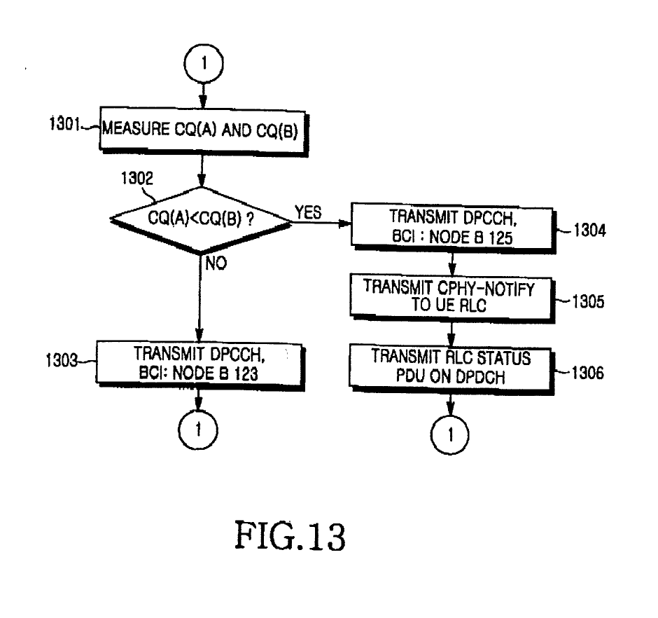

FIG. 13 is a flowchart illustrating a user data transmission method in a UE in the HSDPA mobile communication system according to the embodiment of the present invention. The following description is made with the appreciation that the best cell Node B is the Node B 123 and an active cell Node B is the Node B 125.

Referring to FIG. 13, the UE 130 measures the channel statuses CQ(A) and CQ(B) of the Node Bs 123 and 125 in step 1301. The UE compares the channel status CQ(A) and CQ(B) in step 1302. If CQ(A) is better than CQ(B), the UE 130 transmits a BCI indicating the Node B 123 on a DPCCH to the Node Bs 123 and 125 in step 1303. On the other hand, if CQ(B) is better than CQ(A), the UE 130 transmits a BCI indicating the Node B 125 on the DPCCH to the Node Bs 123 and 125 in step 1304. The UE 130 transmits CPHY-NOTIFY to its RLC, indicating the switching of the best cell in step 1305. The RLC of the UE 130 transmits an RLC STATUS PDU to the SRNC 121 on a DPDCH in step 1306. The RLC of the SRNC 121 then retransmits RLC PDUs that have not been transmitted to the UE 130 based on the RLC STATUS PDU.

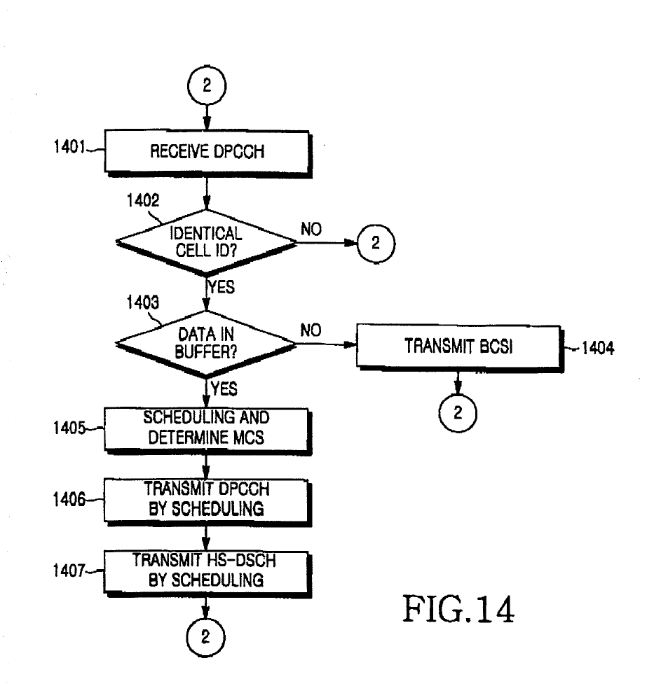

FIG. 14 is a flowchart illustrating a user data transmission method in a Node B in the HSDPA mobile communication system according to the embodiment of the present invention.

Referring to FIG. 14, the Node B 123 or 125 monitors the DPCCH from the UE 130 periodically in step 1401. Upon receipt of the DPCCH, the Node B detects a BCI from the DPCCH and extracts a cell ID from the BCI. If the BCI does not indicate the Node B, the Node B neglects signals after the BCI, i.e., a CQI and an ACK/NACK and returns to step 1401. If the BCI indicates the Node B, the Node B recognizes that it has been selected as the best cell in step 1403. The Node B checks whether its transmission buffer has data to be transmitted. In the absence of transmission data, the Node B goes to step 1404 and in the presence of transmission data, it goes to step 1405. In step 1404, the Node B transmits a BCSI to the SRNC 121, indicating that it has been selected as the best cell and returns to step 1401. In step 1405, the Node B decides an MCS for the downlink transmission and schedules the buffered data and transmits control information including the BCI on a DPCCH in step 1406. The Node B transmits data on the HS-DSCH in step 1407.

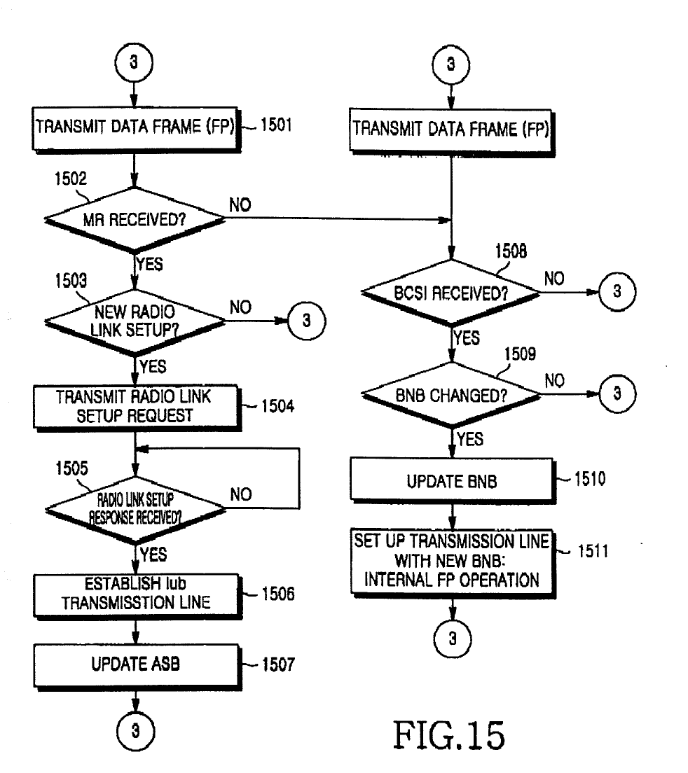

FIG. 15 is a flowchart illustrating a user data transmission method in an SRNC in the HSDPA mobile communication method according to the embodiment of the present invention.

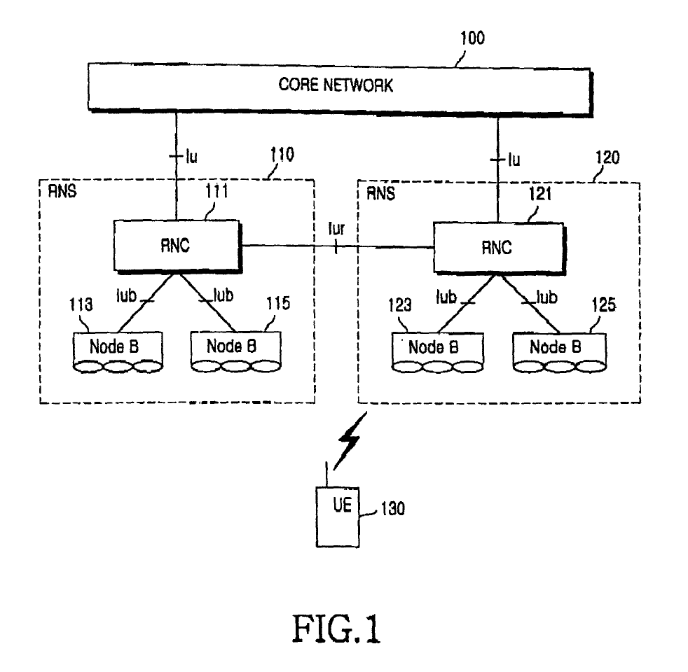

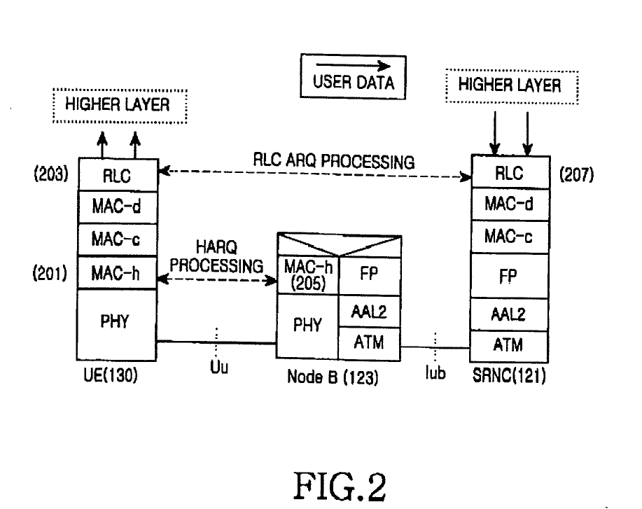

Referring to FIG. 15, the SRNC 121 transmits an FP when it has a data frame to be transmitted in step 1501 and checks whether an MR including the channel status information of the Node Bs 123 and 125 has been received from the UE 130 in step 1502. Upon receipt of the MR, the SRNC 121 determines whether to establish a new radio link in step 1503. In the case of establishing a new radio link, the SRNC 121 transmits a Radio Link Setup Request message to the active set Node B 125 of FIG. 1 in step 1504 and determines whether a Radio Link Setup Response message has been received from the Node B 125 in step 1505. Upon receipt of the Radio Link Setup Response message, the SRNC 121 establishes a lub transmission line with the active set Node B 125 by ALCAP in step 1506 and adds the ID of the active set Node B 125 to the ASB in step 1507. If the MR is not received in step 1502, the SRNC 121 determines whether a BCSI has been received from a particular Node B in step 1508. Upon receipt of the BCSI from the particular Node B, the SRNC 121 determines whether the particular Node B is identical to a Node B set as a best cell Node B in step 1509. If they are different, the SRNC 121 updates the best cell Node B in step 1510 and switches the transmission line to the new best cell Node B.

As described above, transmission of an FP data frame only to the best cell Node B according to the present invention has the following advantages.

(1) lub transmission resources and the buffer resources of active set Node Bs can be used more efficiently;

(2) RLC retransmission requests can be minimized by allowing a Node B to rapidly report the change of the best cell to the FP of an SRNC; and

(3) When the best cell is changed, an RLC retransmission request is rapidly transmitted, thereby efficiently managing the RLC buffer of a UE.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method of transmitting user data to a UE (User Equipment) in a mobile communication system where the same RNC (Radio Network Controller) controls a first Node B, which is currently providing a service to the UE, and at least one neighboring Node B, the UE capable of receiving signals from the first Node B and the at least one neighboring Node B, the method comprising the steps of:
establishing a transmission link with a new Node B based on channel status information of the first Node B and the at least one neighboring Node B received from the UE by the RNC;
monitoring the channel statuses of the first Node B and the at least one neighboring Node B and transmitting an identification (ID) of the best cell Node B based on the channel status to the first Node B and the at least one neighboring Node B by the UE;
transmitting a BCSI (Best Cell Switching Indicator) to the RNC by the at least one neighboring Node B if the best cell Node B ID is identical to the ID of one of the at least one neighboring Node B; and
transmitting user data on the transmission link to the best cell Node B being the one of the at least one neighboring Node B by the RNC.

2. The method of claim 1, wherein the new Node B is the one of the at least one neighboring Node B from which the UE receives a signal.

3. The method of claim 1, wherein the channel statuses of the first Node B and the at least one neighboring Node B are estimated by measuring the reception strengths of CPICHs (Common Pilot Channels) received from the first Node B and the at least one neighboring Node B.

4. The method of claim 1, wherein the best cell Node B ID is coded in a BCI (Best Cell Indicator) field of a DPCCH (Dedicated Physical Control Channel).

5. The method of claim 1, wherein upon receipt of the BCI, the RNC transmits user data only to the at least one neighboring Node B being the new best cell Node B, and discontinues transmission to the first Node B being the old best cell Node B.

6. An apparatus for transmitting user data to a UE (User Equipment) in a mobile communication system, comprising:
a first Node B currently providing a service to the UE, the UE for transmitting channel status information of the first Node B and at least one neighboring Node B, monitoring the channel statuses of the first Node B and the at least one neighboring Node B, and transmitting the identification (ID) of the best cell Node B based on the channel status to the first Node B and the at least one neighboring Node B, the at least one neighboring Node B for transmitting a BCSI (Best Cell Switching Indicator) if the best cell Node B ID is identical to the ID of one of the at least one neighboring Node B; and
an RNC (Radio Network Controller) for establishing a transmission line with a new Node B based on the channel status information received from the UE and transmitting user data on the transmission link to the best cell Node B.

7. The apparatus of claim 6, wherein the new Node B is the one of the at least one neighboring Node B from which the UE receives a signal.

8. The apparatus of claim 6, wherein the channel statuses of the first Node B and the at least one neighboring Node B are estimated by measuring the reception strengths of CPICHs (Common Pilot Channels) received from the first Node B and the at least one neighboring Node B.

9. The apparatus of claim 6, wherein the best cell Node B ID is coded in a BCI (Best Cell Indicator) field of a DPCCH (Dedicated Physical Control Channel).

10. The apparatus of claim 6, wherein upon receipt of the BCI, the RNC transmits user data only to the one of the at least one neighboring Node B being the new best cell Node B, and discontinues transmission to the first Node B being the old best cell Node B.
